(19) United States
(12) Patent Application Publication
(10) Pub. No.: US 2003/0078890 A1
(43) Pub. Date: Apr. 24, 2003

(54) Multimedia content download apparatus and method using same

(76) Inventors: Joachim Schmidt, Helsinki (FI); Peter Ollikainen, Beijing (CN); Frank Dawson, Southlake, TX (US); Matti Salmi, Tampere (FI)

Correspondence Address: STEVEN A. SHAW, NOKIA, INC., 6000 CONNECTION DRIVE, MD 1-4-755, IRVING, TX, 75039, US

(21) Appl. No.: 10/190,798

(22) Filed: Jul. 8, 2002

Related U.S. Application Data
(60) Provisional application No. 60/303,686, filed on Jul. 6, 2001.

(51) Int. Cl. G06F 17/60

(52) U.S. Cl. 705/51

(57) ABSTRACT

An apparatus and method for delivering multimedia content within the mobile world is provided. One embodiment is based on the definition of a smart content object, or content package format, along with provision for specifying meta-information about the digital rights associated with the content. The format is defined in terms of two alternative MIME content subtypes. The first is defined for delivering clear-text, XML representation of the content package. The other is defined for deliverying binary, WBXML representation of the content package. The clear-text MIME type is useful in robust network environments that are not sensitive to limitations, such as were bandwidth can be a limiting factor on application deployment (e.g., the mobile world).

### CROSS-REFERENCE TO RELATED APPLICATIONS

This application claims priority under 35 USC 119 to U.S. Provisional Application Serial No. 60/303,686 filed on Jul. 6, 2001. This application is also related to A Method, System, and Computer Program Product for Controlling the Distribution of a Digital Asset in a Mobile Environment, filed on Mar. 12, 2002, assigned U.S. Ser. No. 10/095,062, assigned to the assignee of the present application and incorporated herein by reference.

The copyright owner has no objection to the reproduction by anyone of this patent document as it appears in the United States Patent and Trademark Office files, but otherwise reserves all copyright rights whatsoever.

### BACKGROUND

Abbreviations

| | |
|---|---|
| DRI | Digital Rights Information |
| DRM | Digital Rights Management |
| SCO | Smart Content Object |
| XML | Extensible Markup Language |
| WBXML | WAP Forum Binary Representation for XML |

References

RFC2045, http://www.ietf.org/rfc/rfc2045.txt

RFC2279, http://www.ietf.org/rfc/rfc2279.txt

RFC2396, http://www.ietf.org/rfc/rfc2396.txt

XML, http://www.w3.org/TR/2000/REC-xml-20001006

The references above are incorporated herein by reference.

The invention relates generally to multimedia content delivery. More particularly, the invention relates managing access to digital information.

The word “MUST”, “MUST NOT”, “REQUIRED”, “SHALL”, “SHALL NOT”, “SHOULD”, “SHOULD NOT”, “RECOMMENDED”, “NOT RECOMMENDED”, “MAY” and “OPTIONAL” refer to the preferred embodiment of the invention and may not apply to all embodiments, modifications or changes, in form and shape, may be made therein without departing from the scope and spirit of the invention.

In order to provide incentive to develop new software products, protection of software copyright protection is a very important issue. Detection of rogue CDs and other means of the physical distribution of software may be accomplished by observation of the distribution channel. However, when the distribution channel is in the internet world, detection is difficult as there is no physical copying. What is needed for protection of software content distributed over digital communication channels is a trusted system.

A company which has developed technology to provide trusted systems is InterTrust Technologies Corporation (Sunnyvale, Calif.). Information about InterTrust is available on the web at http://www.intertrust.com.

Another such technology is the CyberSales Solution of SoftLock.com, Inc. of Maynard, Mass., as described in U.S. Pat. No. 5,509,070. CyberSales Solution provides locking and unlocking functionality so that content can be securely previewed by consumers, electronically purchased and redistributed, and it protects the content in an initial transaction and in subsequent information pass-along. Content providers can control how much information is available without paying, and disable, or additionally charge for, the ability to print or cut and paste. CyberSales Solution handles secure transactions, remittance processing, reports, audits and customer service. Information about CyberSales Solution is available on the web at http://www.softlock.com.

With the advent of the use of compelling multi-media on web pages accessible over the Internet, protection of digital images and other media is becoming increasingly critical. Web designers are reluctant to use valuable digital “works of art” knowing that users can easily copy them onto their own computers, and use them for their own unauthorized purposes. Moreover, anyone using a web browser to view an image posted on the Internet can easily copy the image by simply positioning a mouse pointer over the displayed image, clicking on the right mouse button and selecting a “Save Image As . . . ” command. Copyright and piracy issues are major problems for web publishers.

Prior art techniques for protecting digital images include the embedding of invisible digital watermarks within images, so that copies of protected images can be traced. Digimarc Corporation (Lake Oswego, Oreg.) embeds hidden messages within pixel data for identifying protected images and tracks their distribution over the Internet to monitor potential copyright infringement. Digimarc images carry unique IDs that link to pre-determined locations on the web. Digimarc images are compatible with standard image formats, such as JPEG, and can be opened and displayed by standard image readers. However, when opened with a Digimarc reader, the images are displayed together with a “Web look up” button that enables a user to identify the sources of the images. Information about Digimarc is available on the web at http://www.digimarc.com.

These techniques are useful in thwarting digital image piracy to the extent that they trace pirated content, but they do not prevent unauthorized copying of digital images in the first place.

Other prior art techniques require a webmaster to modify images residing on a server computer in order to protect them. The webmaster is also required to modify his web pages accordingly, so as to reference the modified images. SafeMedia is a software product of Internet Expression, Inc. (Exton, Pa.) that converts images from a standard format such as JPEG into a SIF (Safe Image Format). SIF images can only be viewed with a SafeMedia Java viewer. SafeMedia embeds a host or domain name into an image, and checks that the image is located on the web site it was intended for. SafeMedia also includes enhanced system control for preventing screen capture by disabling a clipboard. Information about SafeMedia is available on the web at http://www.safemedia.com.

These techniques are difficult to embrace, since they require modification of all protected images on the web, as well as modification of the web pages that reference them. Furthermore the SIF Java viewer has the limitation of only being able to load images from the same server that the viewer came from.

Other prior art techniques for protecting digital images use Java applets within web browsers to disable the menu that pops up when a user right clicks on a displayed image within his web browser. Copysight is a software application of Intellectual Protocols, LLC (Nanuet, N.Y.) that uses digital watermarking and fingerprinting to protect images, and includes a Java applet that disables the ability to save displayed images within a web browser and the ability to print them. Copysight operates by converting unprotected files to protected files that are encrypted and that contain digital fingerprints. Copysight also tracks distribution of protected images across the Internet, and issues reports of potential copyright infringement. It allows a web administrator to select which files are to be protected. Information about Copysight is available on the web at http://www.ip2.com.

These techniques disable unauthorized copying of digital images from within web browsers, but they do not protect the images from copying by an application external to the web browser. For example, they do not prevent a user from copying digital images displayed in his web browser by means of an application running external to the web browser, such as an image editing tool, or by means of a Print Screen or other such command that serves to copy contents of a video buffer to a clipboard. Thus a Java applet that prevents unauthorized copying of digital images from within Netscape Communicator or Internet Explorer can be circumvented by a user pressing on a Print Screen button of his keyboard, or by a user copying and pasting from a window of his web browser to a window of another software application.

The rapid deployment of copyrighted multimedia content within the mobile domain has added a new challenge to managing access to digital information. Traditional access modes (i.e., Rich Call, Messaging and Browsing) will need to be augmented with a common framework for handling and managing digital rights associated with such multimedia content. The requirement for this framework comes from the content providers, themselves. Content providers need to be assured that the rights given a recipient of their content will be respected. Such assurances will facilitate wider and more rapid adoption of multimedia content in the mobile world.

Legal and regulatory means exist to protect digital content, however a deterrent is necessary to make the illicit copying and distribution of copyrighted content difficult and traceable. For this reason, the deployment of a trusted end-to-end solution for the management of digital rights is a necessary precursor to digital production, dissemination and consumption of copyrighted content.

Digital Rights Management (“DRM”) involves the description, layering, analysis, valuation, trading, and monitoring of an owner's property rights to an asset. DRM covers the management of the digital rights to the physical manifestation of a work (e.g., a textbook) or the digital manifestation of a work (e.g., a Web page). DRM also covers the management of an asset whether the asset has a tangible or an intangible value. Current DRM technologies include languages for describing the terms and conditions for an asset, tracking asset usage by enforcing controlled environments or encoded asset manifestations, and closed architectures for the overall management of the digital rights.

The Open Digital Rights Language (“ODRL”) provides the semantics for DRM for open and trusted computing environments. ODRL defines a standard vocabulary for expressing the terms and conditions over an asset. ODRL covers a core set of semantics for these purposes including the identification of the property rights to the work and the expression of permissible uses for manifestations of a protected asset. Rights can be specified for a specific asset manifestation or format or could be applied to a range of manifestations of the asset. ODRL does not enforce or mandate any policy for DRM, but provides the mechanisms to express such a policy. ODRL does not, however, assume the existence of mechanisms to achieve a secure architecture. ODRL complements existing rights management standards by providing digital equivalents and supports an expandable range of new services that can be afforded by the digital nature of the assets in the Web environment. In the physical environment, ODRL can be used to enable machine-based processing for DRM. For more information, see the web sites http://odrl.net and http://www.oasis-open.org/cover/odrl.html.

The Extensible Markup Language (“XML”) is a standard for exchanging data and metadata electronically. Metadata is data that describes data. For example, the term “author” is metadata that describes the data “William Shakespeare”. XML is an outgrowth of the Standard Generalized Markup Language (“SGML”) that allows the author of an XML document to separate the logical content of the document from the presentation of the content. An author of an XML document adds metadata to a document as hypertext transfer protocol (“HTTP”) tags in the document. A document type definitions (“DTD”) file is the mechanism that adds shared content to the XML document. For more information, see the web site http://www.oasis-open.org/cover/xml.html.

Extensible Rights Markup Language (“XrML”) is an XML conforming language definition that specifies rights, fees, and conditions for using digital content. XrML also describes message integrity and entity authentication rules. XrML supports commerce in digital content such as publishing and selling electronic books, digital movies, digital music, interactive games; and computer software. In addition, XrML supports the specification of access and use controls for secure digital documents in cases where financial exchange is not part of the terms of use. For more information, see the web site http://www.xrml.org.

There is a need to provide intelligent handling of received content based on associated, simple or lightweight digital rights information to the content and the solution is provided by the framework of a smart content object.

### SUMMARY

Embodiments of the present invention provide an apparatus and method for delivering multimedia content within the mobile world. One embodiment is based on the definition of a smart content object, or content package format, along with provision for specifying meta-information about the digital rights associated with the content. The format is defined in terms of two alternative MIME content subtypes. The first is defined for delivering clear-text, XML representation of the content package. The other is defined for delivering binary, WBXML representation of the content package. The clear-text MIME type is useful in robust network environments that are not sensitive to limitations, such as were bandwidth can be a limiting factor on application deployment (e.g., the mobile world).

Use of embodiments of the present invention decouples the encapsulation of multimedia content from digital rights information (DRI). The DRI can either be specified in line or can be specified as a pointer out to the actual DRI in either the form of a voucher or actual property specification.

Embodiments of the present invention also decouples encapsulation of the DRI specification from the multimedia content. The content can actually be specified as a pointer to a remote store or database. That is, the actual object one exchanges is a shell containing digital rights with pointer to where recipient needs to go to get information.

The format of the Smart Content Object in accordance with embodiments of the present invention is designed to be self-contained with routing information resident within the object itself. The format is also defined in an easily identifiable format that promotes interoperability, multiple vendor implementations, and choice of products for consumer. Preferably, the format is registered as an open Internet “MIME” (Multipurpose Internet Multimedia Extensions) object. This allows it to be easily identifiable using universal content-type mechanism adopted across the Internet and within computing environments.

Format is also transfer mechanism independent. The Smart Content Object in accordance with embodiments of the invention may be transferred over the Web, WAP, SMS, MMS, e-mail, voice/data calls and the like. The first is defined for delivering clear-text, XML representation of the content package. The other is defined for delivering binary, WBXML representation of the content package. The clear-text MIME type is useful in robust network environments that are not sensitive to limitations, such as were bandwidth can be a limiting factor on application deployment (e.g., the mobile world).

Use of embodiments of the present invention decouples the encapsulation of multimedia content from digital rights information (DRI). The DRI can either be specified in line or can be specified as a pointer out to the actual DRI in either the form of a voucher or actual property specification.

Embodiments of the present invention also decouples encapsulation of the DRI specification from the multimedia content. The content can actually be specified as a pointer to a remote store or database. That is, the actual object one exchanges is a shell containing digital rights with pointer to where recipient needs to go to get information.

The format of the Smart Content Object in accordance with embodiments of the present invention is designed to be self-contained with routing information resident within the object itself. The format is also defined in an easily identifiable format that promotes interoperability, multiple vendor implementations, and choice of products for consumer. Preferably, the format is registered as an open Internet “MIME” (Multipurpose Internet Multimedia Extensions) object. This allows it to be easily identifiable using universal content-type mechanism adopted across the Internet and within computing environments.

Format is also transfer mechanism independent. The Smart Content Object in accordance with embodiments of the invention may be transferred over the Web, WAP, SMS, MMS, e-mail, voice/data calls and the like.

Format is also defined in a future proof syntax that will allow inclusion of feature extension without disrupting the existing implementations. For example, the format is specified as an XML based representation. New features may be included merely by insertion of a new XML element types from a new name space.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention, for which reference should be made to the appended claims.

### BRIEF DESCRIPTION OF THE DRAWINGS

FIG. 1 illustrates an example of a content distribution environment in which a preferred embodiment operates.

FIG. 2 is a model for content delivery scenarios.

FIG. 3 is a model for content delivery scenarios using intermediary(ies) in content delivery.

FIG. 4 is illustrative of a Smart Content Object (SCO) format architecture in accordance with an embodiment of the present invention.

FIG. 5 specifies the port number associated with SmartMessaging based applications in accordance with an embodiment of the invention.

FIG. 6 shows that various applications may be assigned port numbers in accordance with an embodiment of the invention.

FIG. 7 specifies the WBXML tag token associated with element type names in accordance with an embodiment of the invention.

FIG. 8 shows the other element type names, which may be associated by a WBXML tag token.

FIG. 9 specifies content elements, description and conformance requirement for the preferred embodiment of the present invention.

### DETAILED DESCRIPTION

A method and apparatus for delivering multimedia content within the mobile world is provided.

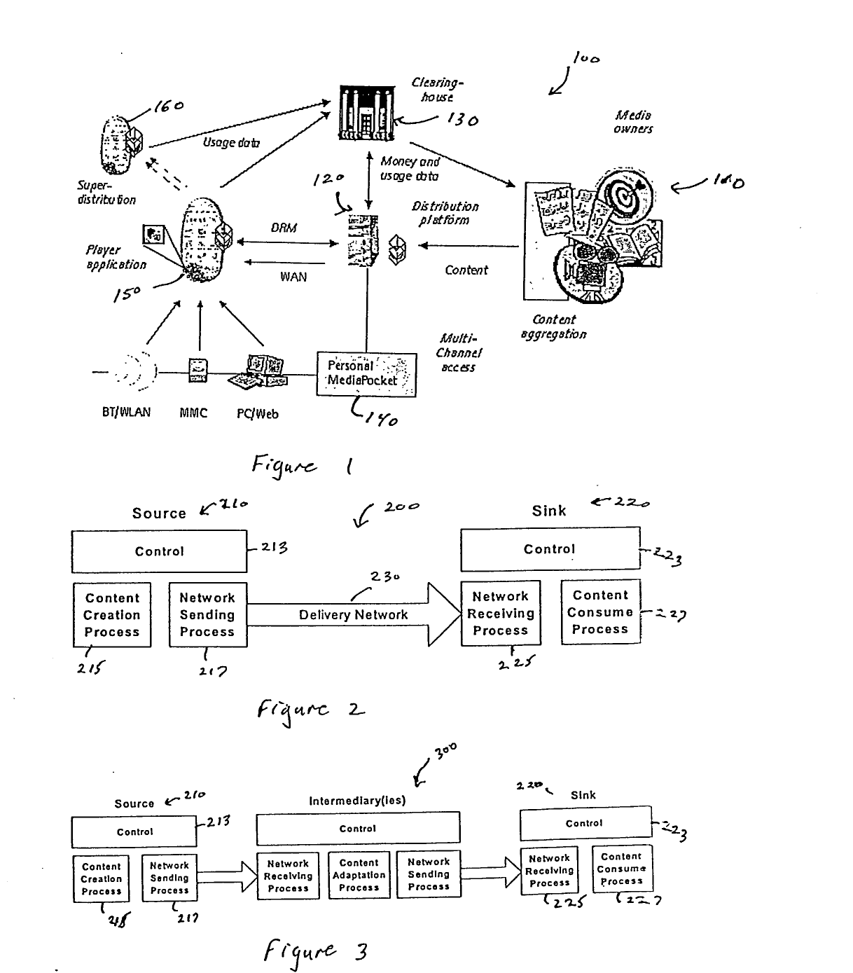

FIG. 1 is illustrative of the distributive environment in which the preferred embodiment of the invention operates. Distribution system 100 comprises media owners 110 who provide a source for digital content for distribution expecting secure transmission and management of their ownership rights. A digital rights server 120 is provides a distribution platform from which the digital content is distributed, usage data is maintained and digital credits/debits are exchanged. Clearinghouse 130 provides for clearance of rights obtains digital credits/debits and usage information from server 120. An example of such a clearinghouse is BMI. Personal MediaPocket 140 provides for multichannel distribution. Digital content is also provide to wireless user by a Personal Trusted Device (PTD) 150 which can be further distributed to other users 160 if rights permit. An example of this would be an interactive game among many users of a player application.

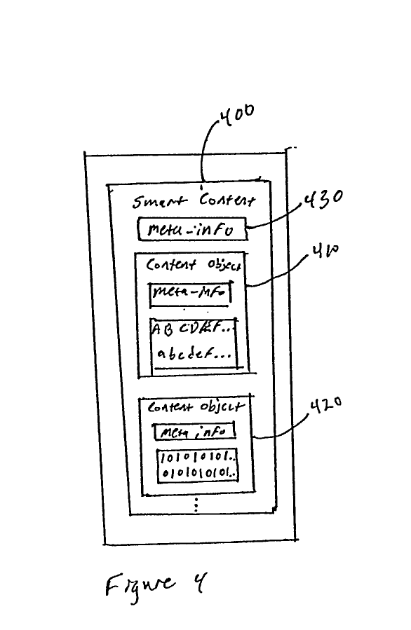

FIG. 2 is a generic model for content delivery scenarios 200. There are two network end-points for digital content: a source 210 and sink 220. The source end-point provides content to the sink end-point, which consumes the content. Between the source and the sink, the content is delivered over delivery network(s). Both end points have three processes. In the source end-point, the processes are content creation 215, content delivery control 213, and network sending processes 217. In the sink end-point, they are network receiving 225, content consume control 223, and content consume processes 227.

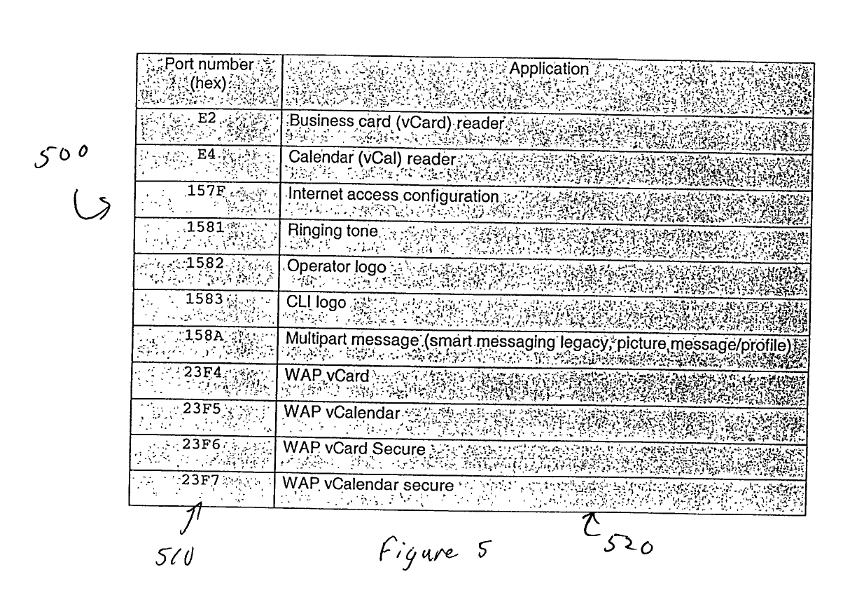

In some content delivery scenarios, the content may be delivered between the source and the sink end-points via a third end-point or group of end-points, called intermediary end-point(s) as shown in FIG. 3. In the simplest case, the intermediary end-point only receives the content from the source end-point and forwards it to the sink end-point. In more complicated scenarios, the intermediary end-point processes the content (e.g. reformat or adapt the content) before sending it forward.

The solution is based on the definition of a smart content object, or content package format, along with provision for specifying meta-information about the digital rights associated with the content. The format is defined in terms of two alternative MIME content subtypes. The first is defined for delivering clear-text, XML representation of the content package. The other is defined for delivering binary, WBXML representation of the content package. The clear-text MIME type is useful in robust network environments that are not sensitive to limitations, such as were bandwidth can be a limiting factor on application deployment (e.g., the mobile world).

Both the clear-text and binary forms of the smart content object are isomeric representations of each other. One can be transcoded into the other (and back) without any loss of information. The smart content object defined by the appended claims is referred to as the Smart Content Object (SCO) MIME format.

FIG. 4 shows a SCO format in accordance with an embodiment of the present invention. SCO format 400 provides an encapsulation mechanism for one or more multimedia objects 410, 420 . . . , as well as the meta-information 430 describing any digital rights information (DRI) associated with each multimedia object.

Digital Rights Information (DRI)

DRI is meta-information about the access rights and usage patterns assigned to the content by the content provider (source). It may also specify the rightsholder information or secure characteristics of the content. The intent for specifying the DRI meta-information is that the DRI will be enforced by the recipient (sink). This will generally be enabled by the recipient recognizing the MIME media type; passing the received SCO entity to a resident object handler; that will enforce the rights given the recipient. Without DRI, content can be used in ways counter to those intended for the object by the content owner. For example, a read-only content can be copied or modified or a logo of a product can be rendered with sound bytes from a competitor's product.

DRI differentiates the encapsulation provided by the SCO of the present invention from standard encapsulation mechanism such as the nominal MIME specification.

Preferably, the SCO format does NOT define its own DRI schema. Instead, it leverages DRI schema from an external specification. This version of the SCO makes use of the NOKIA Lightweight Digital Rights Management (LDRM) specification, (Nokia Corporation; Finland and Irving, Tex.), for specifying DRI constraints on the multimedia content.

Multimedia Content

SCO format is intended to be useful for conveying the associated application and digital rights information for any number of multimedia (i.e., content) objects. The content can either be included in the SCO format or can be located externally and just referenced from within the SCO format.

If included within the SCO format, individual multimedia objects are identified by their MIME media “type/subtype”, as would be specified in a Content-Type MIME header. For example, simple plain text is identified by the “text/plain” IANA registered identifier. Experimental MIME types can also be conveyed in a SCO format. Experimental MIME types are distinguished by a “X-” prefix on the “type/subtype” media content type identifier.

In addition, if the content is included within SCO format, the transfer format for the multimedia objects may need to be specified. Preferably, when conveyed in the clear-text, XML representation of the SCO format, binary content in the preferred embodiment MUST first be character-encoded using the Base64 character-encoding mechanism defined in [RFC2045] “Multipurpose Internet Mail Extensions (MIME) Part One: Format of Internet Message Bodies.”

When conveyed in the binary, WBXML representation of SCO format, binary format is transferred in the native binary form.

Preferably, both the content-type and the transfer format MUST be specified either implicitly (i.e., with the default values) or explicitly for each content object included in the SCO format.

XML Usage

The SCO format is defined in terms of the clear-text XML representation. The SCO format is specified using well-formed XML. Individual XML documents conforming to the SCO format need not be valid XML. That is, the SCO format does not need to specify the XML declaration or prolog. It only needs to specify the body of the XML document. This restriction allows for the SCO format to be specified with greater terseness than well-formed, valid XML documents.

The SCO format makes heavy use of XML name spaces. Preferably, name spaces MUST be declared on the first element type that uses an element type from a name space other than the default, SCO name space.

Names in XML are case sensitive. By convention in the SCO DTD, the element type names are specified with a “Hungarian” like notation of the first character in each word of the name in upper case text and remainder of the characters in each word of the names specified in lower case text. For example, SCO for the SCO root element type tag.

The element types in the SCO DTD are defined within a namespace associated with the URI http://www.nokia.com/clubnokia/sco.dtd or the URN nokia:scov10. The SCO DTD is also identified by the ISO 9070 formal public identifier -//Nokia//DTD SCO 1.0//EN.

The format in accordance with the present invention makes use of the Nokia Lightweight Digital Rights Management (LDRM) name space for specifying digital rights information in the SCO meta-information element type. The full Nokia Rights Voucher is defined in a separate U.S. patent application Ser. No. 10/095,062 filed on Mar. 12, 2002 and is incorporated herein by referenced.

SCO format also makes use of XML standard attributes, such as xmlns and xml:lang. Any XML standard attribute can be used in the Nokia SCO format.

The clear-text, XML representation of a document is more verbose than an alternative WBXML, binary representation. Preferably, for applications of the SCO format where terseness is important, the binary, WBXML representation SHOULD be used.

SCO Format Definition

The SCO format in accordance with an embodiment of the present invention defines a multimedia content package that provides a framework for delivery of multimedia content with associated DRI. The format is defined in terms of a XML document type and registered in IANA as a new MIME subtype under the “application/vnd” sub-tree. The SCO format is defined as an XML DTD specification.

SCO Element Type Description

The SCO format consists of XML element types that specify both the multimedia content and associated DRI meta-information. In particular, there is an element type that announces the format and others that specify format versioning, originator identity, and DRI meta-information.

SCO serves as the root element type for the SCO format.

Content Model: (Version?, Source?, Target*, TransID?, (Content)+)

Attributes:

| Name | Type | Defaultability |
|---|---|---|
| xmlns | CDATA | IMPLIED |

Description: Specifies the name space for the SCO element types. If specified the value MUST be “nokia:nscv10”. If implied, then assumed to also be this value. The element type MUST be the first element type in the SCO format, following any optional, standard XML prolog element types.

Example: A simple SCO example.

<SCO>

<Content>

<Data>Blah, blah, blah text/plain content</Data>

</Content>

</SCO>

A simple SCO example with external reference to content.

<SCO>

<Content>

<ExtRef>http://www.host.com/foo.bar</ExtRef>

</Content>

</SCO>

Version specifies the SCO specification version used to represent the smart content object.

Content Model: (#PCDATA)

Attributes: None

Description: The element type SHOULD be specified in the SCO format. If absent, then assumed to be “1.0”.

Example:

<SCO>

<Version>1.0</Version>

<Content>

<Data>Blah, blah, blah text/plain content</Data>

</Content>

</SCO>

Source specifies the network source of the SCO format.

Content Model: (LocURI, LocName?)

Attributes: None

Description: The optional element type MAY appear only once in the Nokia SCO format. If absent, the network source of the Nokia SCO format can be implied from information provided by the bearer for the content. For example, the SMS originator or the CSD origination point. However, in most cases when absent the network source will be ambiguous or not defined. Hence, the element SHOULD be specified by the originator of the Nokia SCO format in all cases where the recipient might need to reply or make subsequent requests.

The required LocURI element type specifies the URI-based, as defined by [RFC2396] “Uniform Resource Identifiers (URI): Generic Syntax,” network address of the resource that originated the Nokia SCO format. Generally, this can also be assumed to be the network entity that created the Nokia SCO format. The value MUST be a network unique identifier. It is recommended that the URI be of a format that conveys the protocol scheme needed to access the source of the smart content object (e.g., http://www.host.com for a HTTP based URI). Specifying a URI of an entity that is not accessible from the network by the recipient (i.e., the URI specified by the Target) defeats the purpose for specifying this element type and SHOULD NOT be used as a value.

The optional LocName element type specifies the display name or account name for the resource that originated the Nokia SCO format. This specification places no requirements on the localization of the display name. The display name is provided as an aid in differentiating, possibly, obtuse URI values.

Example: Simple example of a HTTP based URI for Source value.

<SCO>

<Version>1.0</Version>

<Source><LocURI>http://www.host.com/nsc-server</LocURI></Source>

<Target><LocURI>IMEI:123456789012345</LocURI></Target>

<Content><Data>Blah, blah, blah text/plain content</Data></Content>

</SCO>

Simple example of a telephone call based URI for Source value. The implication is that a mobile phone call to the Source value will be sufficient to contact the network entity that originated the Nokia SCO format. The Telephone Call URL scheme is specified in RFC 2806.

<SCO>

<Version>1.0</Version>

<Source><LocURI>tel:+358-555-1234567</LocURI></Source>

<Target><LocURI>IMEI:123456789012345</LocURI></Target>

<Content><Data>Blah, blah, blah text/plain content</Data></Content>

</SCO>

Target specifies the intended network target of the SCO format.

Content Model: (LocURI, LocName?)

Attributes: None

Description: The optional element type MAY appear once in the Nokia SCO format. If absent, the intended network target for the Nokia SCO format is implicit. For example, the SMS recipient or the CSD endpoint.

The required LocURI element type specifies the URI-based, as defined by [RFC2396] “Uniform Resource Identifiers (URI): Generic Syntax,” network address of the intended target for the Nokia SCO format.

The optional LocName element type specifies the display name or account name for the intended network resource that is the target for the Nokia SCO format. This specification places no requirements on the localization of the display name. The display name is provided as an aid in differentiating, possibly, obtuse URI values.

Example: In the following example, an IMEI URI format is assumed for the URI protocol scheme for the Target value.

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<Content><Data>Blah, blah, blah text/plain content</Data></Content>

</SCO>

LocURI specifies the network address or location URI of a Source or Target.

Content Model: (#PCDATA)

Attributes: None

Description: The element type is required in a Source or Target element type.

Uniform Resource Identifiers (URI) provide a simple and extensible means for specifying addresses of network resources or entities. The URI can be either a Uniform Resource Locator (URL) formatted value or a Uniform Resource Name (URN) formatted value.

Example:

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<Content><Data>Blah, blah, blah text/plain content</Data></Content>

</SCO>

LocName specifies the display name or account name for a Source or Target.

Content Model: (#PCDATA)

Attributes: None

Description: The optional element type can appear only once in a Source or Target. If absent, the display name is not specified by the Nokia SCO format.

The LocName element type specifies the display name or account name for the network resource. This specification places no requirements on the localization of the display name. The display name is provided as an aid in differentiating, possibly, obtuse URI values.

Example:

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<Content><Data>Blah, blah, blah text/plain content</Data></Content>

</SCO>

TransID specifies the transaction identifier associated with the SCO format.

Content Model: (#PCDATA)

Attributes: None

Description: The optional element type can appear only once in the Nokia SCO format. If absent, then no assumptions can be made about the management of the content distribution based on a transaction identifier.

The transaction identifier is specified as a tool for identifying individual distribution activities for multimedia content. This specification does not define any application for this value. However, the value could be used in application of scenarios such as to refer to content distribution transactions in logging applications, auditing applications, requests for renewal of content or extension to digital rights.

The value MUST be a value that is unique within the scope of the network resource that originated the Nokia SCO format. With the unique Source value, a globally unique tuple can be formed for uniquely identifying the transaction across an extended network, such as the Internet.

Example: An example of a simple transaction identifier value.

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<TransID>1</TransID>

<Content><Data>Blah, blah, blah text/plain content</Data></Content>

</SCO>

Example: An example of a more complicated transaction identifier value.

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<TransID>358405551234-20010305T194600Z-AA01</TransID>

<Content><Data>Blah, blah, blah text/plain content</Data></Content>

</SCO22

Content is a container for the multimedia content carried in the SCO format.

Content Model: (LocURI?, ToolURI?, ApplURI?, Meta?, Type?, Format?, (Data | ExtURI))

Attributes: None

Description: The optional LocURI element type specifies the network address of the resource that created or is the administrator for the multimedia content. This value provide a possible method for both identifying the content source (i.e., possibly different than the source of the Nokia SCO format). If absent, then then no assumptions can be made about the creator of the content. That is, the network resource that created the multimedia content is undefined by the Nokia SCO format.

The optional ToolURI element type specifies the software application or tool that created the multimedia content. In many cases, knowledge about the application that created the content information can assist in proper rendering of the content information. If absent, then no assumption SHOULD be made about the software application or tool that created the content.

The optional ApplURI element type specifies the software application that is the intended target usage for the multimedia content. In this case, the “target” implies the intended rendering application. For example, a digital sound content could be intended for use in a ringtone rendering application or for use in a calendar application as an audio reminder. If absent, then the multimedia content has no usage assumptions.

The optional Meta element type specifies any DRM meta-information associated with the multimedia content. The value MUST be Nokia Rights Voucher markup representation of the digital rights information for this content. The Nokia Rights Voucher markup MUST explicitly specify the name space for the markup. If absent, then there are no constraints on the distribution of the content.

The optional Type element type specifies the MIME media type for the multimedia content. If absent, the “text/plain” media type is to be assumed.

The optional Format element type specifies the transfer format for the multimedia content. The values defined by this specification include: chr, for clear-text, character data in the default character set of the XML document; xml, for XML markup; or b64 for Base64 character-encoded data. If absent, the default value is chr.

The multimedia content is either inline in the Data element type or external to the Nokia SCO format and referenced by an inline URI value in the ExtRef element type. Either the Data element type or the ExtRef element type MUST be specified.

Example: Simple example of inline content

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<TransID>1</TransID>

<Content><LocURI>http://www.mytext.com</LocURI>

<ToolURI>http://www.texttool.com</ToolURI><Type>text/plain</Type>

<Format>chr</Format>

<Data>Blah, blah, blah text/plain content</Data>

</Content>

</SCO>

ToolURI specifies the identifier for the authoring tool used to create the SCO format.

Content Model: (#PCDATA)

Attributes: None

Description: The optional element type MAY appear once in a Nokia SCO format.

Example:

<SCO>

<Version>1.0</Version>

<Source><LocURI>http://www.host.com/nsc-server</LocURI></Source>

<Target><LocURI>IMEI:123456789012345</LocURI><LocName>John Smith +358 40 555 1234</LocName></Target>

<TransID>1</TransID>

<content><LocURI>http://www.mytext.com</LocURI>

<ToolURI>http://www.texttool.com</ToolURI><Type>text/plain</Type>

<Format>chr</Format>

<Data>Blah, blah, blah text/plain content</Data>

</Content>

</SCO>

ApplURI specifies the URI based identifier of the application intended for rendering the Nokia SCO format on the recipient.

Content Model: (#PCDATA)

Attributes: None

Description: The optional element type specifies either the SmartMessaging port number for the intended application or a URI of the intended application.

If a port number is specified, then the value is formatted in the form “nokia:sm-port-xxxx”, where xxxx is either the two-digit or four-digit port number associated with the application.

If the URI of the intended application is specified, then the ISBN number associated with the published software application SHOULD be used as the URI value when it exists (e.g., ISBN:951-762-214-7-1994). Otherwise, the URI can be any other form of uniform resource identifier associated with the application.

FIG. 5 specifies the port number associated with SmartMessaging based applications. Chart 500 shows port number in hex that may be assigned to various applications 520. E.G., in the exemplar, E2 (hex) or v Card, 1581 (hex) for a ringing tone . . .

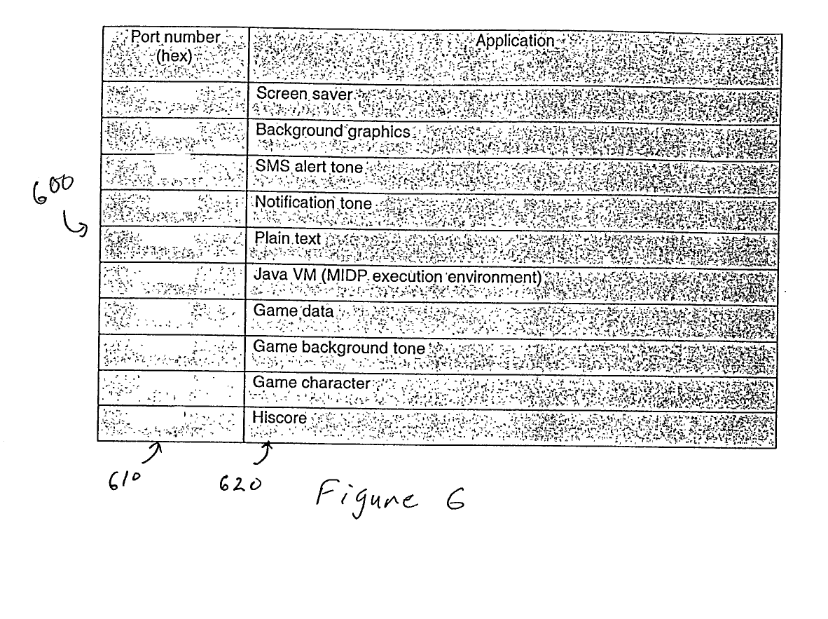

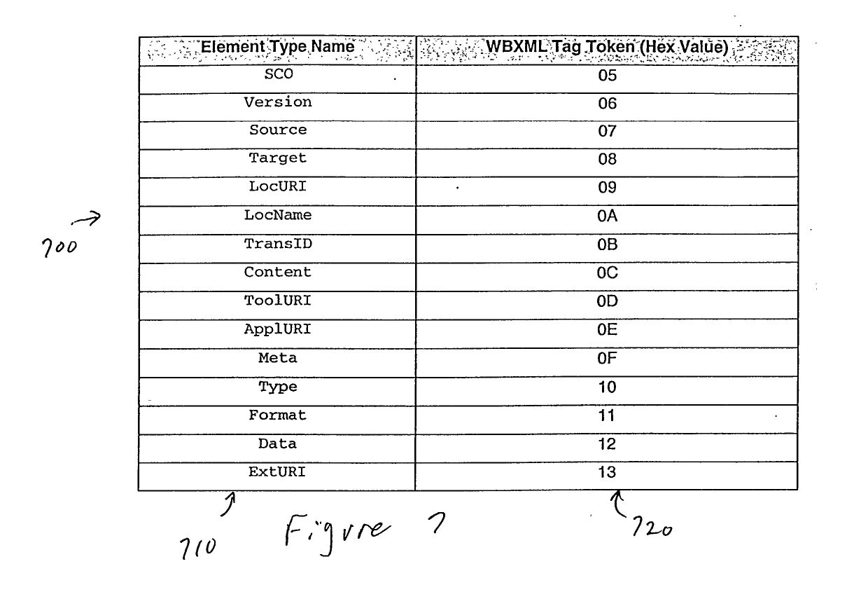

FIG. 6 shows a chart 600 wherein port numbers 610 may be assigned to other applications 620 such as for screen saver, game tone, hi score and other game data.

Example:

<SCO>
<version>1.0</Version>
<Source><LocURI>htp://www.host.com/nsc-server</LocURI></Source>
<Target><LocURI>IMEI: 123456789012345</LocURI><LocName>John Smith
+358 40 555 1234</LocName></Target>
<TransID>1</TransID>
<Content>
<ApplURI>nokia:sm-port-1581</APPlURI>
<Type>nokia:ringtone</Type>
<Format>b64<Format>
<Data>--Base64 of ringtone content-- </Data>
</Content>
</SCO>

1. Meta

Purpose: Specify the DRM meta-information associated with the multimedia content in the Nokia SCO format.

Content Model: (ANY)

Attributes: None

Description: The optional element type specifies any DRM meta-information associated with the multimedia content. The value MUST be Nokia Rights Voucher markup representation of the digital rights information for this content. The Nokia Rights Voucher markup MUST explicitly specify the name space for the markup. If absent, then there are no constraints on the distribution of the content.

Example:

<SCO>
<Version>1.0</Version>
<Source><LocURI>http://www.host com/nsc-server</LocURI></Source>
<Target><LocURI>IMEI: 123456789012345</LocURI><LocName>John Smith
+358 40 555 1234</LocName></Target>
<TransID>1</TransID>
<Content><LocURI>http://www.mytext.com</LocURI>
<ToolURI>http: /www.texttool.com</ToolURI>
<Meta>
<usage xmlns=′nokia:nrv01′>
<execute/>
<save/>
</usage>
</Meta>
<Type>text/plain</Type>
<Format>chr</Format>
<Data>Blah, blah, blah text/plain content</Data>
</Content>
</SCO>

2. Type

Purpose: Specify the MIME media type for the content information in the Nokia SCO format.

Content Model: (#PCDATA)

Attributes: None

Description: The optional element type is defaultable. If absent, the default value is “text/plain”. If not text/plain content type, then the element type MUST be specified with the actual MIME content type of the content information in the Nokia SCO format.

Example:

<SCO>
<Version>1.0</Version>
<Source><LocURI>http://www.host.com/nsc-server</LocURI></Source>
<Target><LocURI>IMEI: 123456789012345</LocURI><LocName>John Smith
+358 40 555 1234</LocName></Target>
<TransID>1<TransID>
<Content><LocURI>http://www.mytest.com<LocURI>
<ToolURI>http://www.texttool.com</ToolURI><Type>text/plain</Type>
<Format>chr</Format>
<Data>Blah, blah, blah text/plain content</Data>
</Content>
</SCO>

3. Format

Purpose: Specify the transfer format of the content information in the Nokia SCO format.

Content Model: (#PCDATA)

Attributes: None

Description: The element type is defaultable. If absent, the default value is chr (i.e., clear-text character format). If not the default value, then the element type is required.

The optional Format element type specifies the transfer format for the multimedia content. The values defined by this specification include: chr, for clear-text, character data in the default character set of the XML document; xml, for XML markup; or b64 for Base64 character-encoded data.

For chr, the character set is that specified for the XML document.

Example:

<SCO>
<Version>1.0./Version>
<Source><LocURI>http://www.host.com/nsc-server</LocURI></Source>
<Target><LocURI>IMEI: 123456789012345</LocURI><LocName>John Smith
+358 40 555 1234</LocName></Target>
<TransID>1</TransID>
<Content><LocURI>http://www.mytest.com</LocURI>
<ToolURI>http://www.texttool.com</ToolURI><Type>text/plain</Type>
<Format>chr</Format>
<Data>Blah, blah, blah text/Plain content</Data>
</Content>
</SCO>

4. Data

Purpose: Specify the content information in the Nokia SCO format, when inline.

Content Model: (ANY)

Attributes: None

Description: Content information in the Nokia SCO format is either included inline or is external to the Nokia SCO format and referenced from within it. If the content information is included in the Nokia SCO format, then it is specified within this element type. The format of the content information is specified by the Format element type. The MIME media type/subtype for the content information is specified by the Type element type.

Example:

<SCO>
<Version>1.0./Version>
<Source><LocURI>http://www.host.com/nsc-server</LocURI></Source>
<Target><LocURI>IMEI: 123456789012345</LocURI><LocName>John Smith
+358 40 555 1234</LocName></Target>
<TransID>1</TransID>
<Content><LocURI>http://www.mytest.com</LocURI>
<ToolURI>http://www.texttool.com</ToolURI><Type>text/plain</Type>
<Format>chr</Format>
<Data>Blah, blah, blah text/Plain content</Data>
</Content>
<SCO>

5. ExtURI

Purpose: Specify the network address of the content information referenced by the Nokia SCO format.

Content Model: (#PCDATA)

Attributes: None

Description: Content information in the Nokia SCO format is either included inline or is external to the Nokia SCO format and referenced from within it. If the content information is external to the Nokia SCO format, then it is referenced by this element type. The format of the content information is specified by the Format element type. The MIME media type/subtype for the content information is specified by the Type element type.

On externally referenced content, the Type element type SHOULD be specified to facilitate access and retrieval of the content information (e.g., minimize the possible negotiation for acceptable content type).

Example:

<SCO>
<Version>1.0./Version>
<Source><LocURI>http://www.host.com/nsc-server</LocURI></Source>
<Target><LocURI>IMEI :123456789012345</LocURI><LocName>John Smith
+358 40 555 1234</LocName></Target>
<TransID>1</TransID>
<Content><LocURI>http://www.mytest.com</LocURI>
<Type>application/x nokia-ringtone</Type>
<ExtRef>http://host.com/ringtones/foo.bar</ExtRef>
</Content>
<SCO>

II. Nokia SCO XML Document Type Definition

The following DTD defines the XML representation for the version of the Nokia SCO format associated with this document.

<?xml version=“1.0” encoding=“UTE-8”?>
<!-- This DTD defines the Noki Smart Content Object (SCO) DTD. The
document type defines a common format for representing a container
for multimedia objects with applied digital rights. This DTD is to
be identified by the URI string “nokia:nscv10”. Single element types
from this name space can be referenced as the following examples
demonstrates:
<SO xmlns=‘nokia:nscv10’>
<Content><Data>blah, blah</Data></Content>
</SCO>
-- >
<!-- Copyright 2001, Nokia Mobile Phones. All rights reserved -->
<!ELEMENT SCO (Version?, Source?, Target*, TransID?, (Content)+)>
<?-- If specified, the XML name space, MUST be “nokia:nscy10”-->
<?ATTLIST SCO

xmlns CDATA #IMPLIED>

<!ELEMENT Version (#PCDATA)>
>!ELEMENT Source (LocURI, LocName?)>
<!ELEMENT Target (LocURI, LocName?)>
>!ELEMENT LocURI (#PCDATA)>
<!ELEMENT LocName (#PCDATA)>
<!ELEMENT TransID (#PCDATA)>
<!ELEMENT Content (LocURI?, ToolURI?, ApplURI?, Meta?, Type?,
Format?, (Data, ExtURI))>
<!ELEMENT ToolURI (#PCDATA)>
<!ELEMENT ApplURI (#PCDATA)>
<!-- DRI element types specified in Meta -->
<!-- DRI element types come from the Nokia Rights Voucher name
space, “nokia.ldrmy10”
<!ELEMENT Meta ANY>
<!ELEMENT Type (#PCDATA)>
<!ELEMENT Format (#PCDATA)>
<!ELEMENT Data ANY>
<′ELEMENT ExtURI (#PCDATA)>

III. Nokia SCO WBXML Definition

The following tables define the WBXML representation for the version of the Nokia SCO format associated with this document.

A. Code Space Definitions

This version of the Nokia SCO specification maps the Nokia SCO format DTD into a single WBXML code space. The Nokia SCO DTD is assigned the WBXML document public identifier (i.e., the “publicid” WBXML BNF production) associated with the FDD token and the Formal Public Identifier (FPI) “-//NOKIA//DTD SCO 1.0//EN”.

B. Code Page Definitions

The Nokia SCO format DTD MUST be mapped into tokens from the code page, “00”.

The Nokia Rights Voucher DTD that is used as markup in the Meta element type MUST be mapped into token from the code page “01” when used in the Nokia SCO WBXML definition.

C. Token Definitions

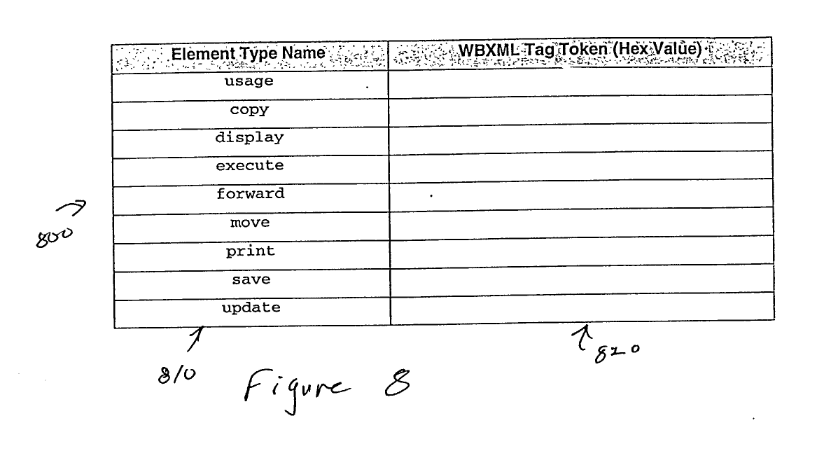

FIG. 7 is a chart 700, listing WBXML token codes 720, which represent element types 710 from the code page x00 (zero), corresponding with the Nokia SCO format DTD in accordance with an embodiment of the present invention. There is no token specified for the explicit declaration of the XML name space attribute because this information is implicit in the WBXML code page switching.

FIG. 8 shows a chart 800, wherein other element types 810 may be provided with WBXML tag token values 820 in the spirit and scope of the embodiments of the present invention.

IV. Static Conformance Requirements

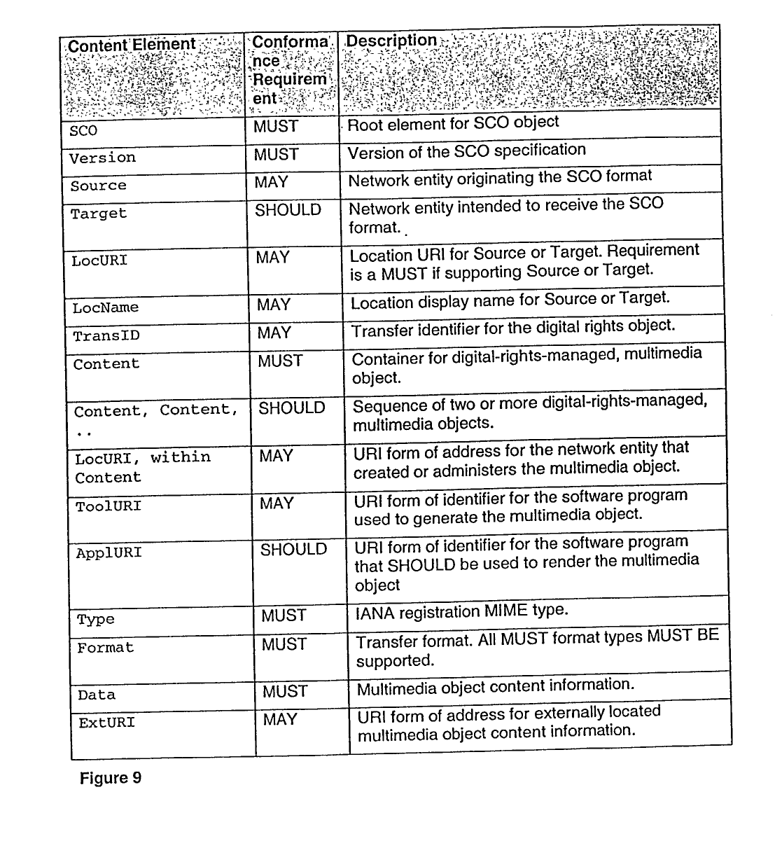

FIG. 9 specifies the static conformance requirements for implementations “sending” and “receiving” the Nokia SCO format, an preferred embodiment of the present invention. The conformance requirements are for the exemplar only. Various elements may or may not be required and still be within the spirit and scope of the present invention.

The term “MUST” means that an implementation conforming to this specification MUST implement the element type in the specified processor mode (i.e., receiving or sending). The term “SHOULD” means that an implementation conforming to this specification MUST implement the element type in the specified process mode unless there is a significant and compelling practical reason why it can not be implemented in the product (e.g., implementation is a open-source example for implementing a Nokia SCO format reader so just ignores the Target element type). The term “MAY” means that an implementation conforming to this specification is recommended to implement the element type in the specified process mode because not implementing the element type may impact interoperability with other products supporting this specification.

The patent application “A Method, System, and Computer Program Product for Controlling the Distribution of a Digital Asset in a Mobile Environment,” filed on Mar. 12, 2002, assigned U.S. Ser. No. 10/095,062, assigned to the assignee of the present application and incorporated herein by reference defines Nokia Rights Voucher name space elements, but utilized in the present application via name space reference.

### V. EXAMPLES

Case Spiderman/animated GIFs, preview/save allowed:

(NOTE: This is the support we would need initially for CUI to get rid of current Spiderman anigif download problem, nothing else required, only couple of DRIflags and screensaver as the AppURI needed+GIF89a format in the data)

<SCO>
<Version;1.0</Version>
<Content>
<Meta>
<usage xmlns=‘nokia:nrv10’><save/><execute/></usage>
</Meta>
<Type>nokia:screensaver</Type>
<Format>b64</Format>
<Data>--Base64 encoded content information --</Data>
</Content>
</SCO>

VI. Nokia SCO MIME Registration

The following is the registration information for the Nokia SCO format. There exist two MIME registrations in the IANA “application/vnd.” sub-tree. The first is for the clear-text, XML representation of the Nokia SCO format. The second is for the binary, WBXML representation of the Nokia SCO format.

A. Clear-text, XML Representation

To: ietf-types@iana.org

Subject: Registration of MIME media type application/vnd.nokia-sco+xml

MIME media type name: application

MIME subtype name: vnd.nokia-sco+xml

Required parameters: None

Optional parameters: charset. May be specified in the Content-Type MIME header field.

Content-Type MIME header.

charset Parameter

Purpose: Specifies the character set used to represent the Nokia SCO document. The default character set for a Nokia SCO document is UTF-8, as defined [RFC2279].

Formal Specification: The following ABNF defines the syntax for the parameter.

charset-param=“;” “charset” “=” <any IANA registered charset identifier>

Encoding considerations: The default character set for the Nokia SCO MIME content type is UTF-8. Transfer of this character set through some MIME systems may require that the content is first character encoded into a 7 bit character set with an IETF character encoding mechanism such as Base64, as defined in [RFC2045].

Security considerations:

Authentication: The SyncML MIME content type definition provides for the inclusion of authentication information for the purpose of authenticating the originator and recipient of messages containing the data synchronization content type. The content type definition supports Basic, Base64 userid/password mark-up, MD5 digest challenge and response strings and any other registered authentication credential scheme.

Threats: The Nokia SCO MIME content type definition provides for the inclusion of arbitrary content information. Administrators for MIME implementations that support this content type SHOULD take every standard precaution to assure the activation of Nokia SCO content is NOT automatic, but is only performed after confirmation by the recipient. In addition, administrators may want to perform virus scans of Nokia SCO content information. The Nokia SCO content can include embedded executable code. Every standard precaution SHOULD be taken by administers for MIME implementations to confirm the validity of the included Nokia SCO content prior to allowing the embedded executable content to be executed on the targeted recipient's system.

Interoperability considerations: Implementations that have support for the mandatory features of this content type will greatly increase the chances of interoperating with other implementations supporting this content type. Conformance to this content type requires an implementation to support every mandatory feature.

Published specification: http://www.club.nokia.com/scov10.pdf

Applications, which use this media type: This MIME content type is intended for common use by networked data transfer applications.

Additional information:

Magic number(s): None

File extension(s): SCO

Macintosh File Type Code(s): NSCO

Intended usage: COMMON

B. Binary, WBXML Representation

To: ietf-types@iana.org

Subject: Registration of MIME media type application/vnd.nokia-sco+wbxml

MIME media type name: application

MIME subtype name: vnd.nokia-sco+wbxml

Required parameters: None

Optional parameters: charset. May be specified in the Content-Type MIME header field.

Content-Type MIME header.

charset Parameter

Purpose: Specifies the character set used to represent the Nokia SCO document. The default character set for a Nokia SCO document is UTF-8, as defined [RFC2279].

Formal Specification: The following ABNF defines the syntax for the parameter.

charset-param=“;” “charset” “=” <any IANA registered charset identifier>

Encoding considerations: The default character set for the Nokia SCO MIME content type is UTF-8. Transfer of this character set through some MIME systems may require that the content is first character encoded into a 7 bit character set with an IETF character encoding mechanism such as Base64, as defined in [RFC2045].

Security considerations:

Authentication: The SyncML MIME content type definition provides for the inclusion of authentication information for the purpose of authenticating the originator and recipient of messages containing the data synchronization content type. The content type definition supports Basic, Base64 userid/password mark-up, MD5 digest challenge and response strings and any other registered authentication credential scheme.

Threats: The Nokia SCO MIME content type definition provides for the inclusion of arbitrary content information. Administrators for MIME implementations that support this content type SHOULD take every standard precaution to assure the activation of Nokia SCO content is NOT automatic, but is only performed after confirmation by the recipient. In addition, administrators may want to perform virus scans of Nokia SCO content information. The Nokia SCO content can include embedded executable code. Every standard precaution SHOULD be taken by administers for MIME implementations to confirm the validity of the included Nokia SCO content prior to allowing the embedded executable content to be executed on the targeted recipient's system.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A descriptive data structure embodied on a carrier-wave to provide for management of multimedia content comprising:
routing information;
digital rights information; and
a plurality of multimedia content, including both text representation and binary representation.

2. The descriptive data structure of claim 1, wherein the digital rights information is a pointer to link a user to a property rights database.

3. The descriptive data structure of claim 1, wherein the data structure is bearer independent.

4. A descriptive data structure embodied on a carrier-wave to provide for management of multimedia content comprising:
routing information;
digital rights information; and
a pointer to a location where a plurality of multimedia content may be retrieved.

5. A descriptive data structure embodied on computer-readable medium to provide for management of multimedia content comprising:
routing information;
digital rights information; and
a plurality of multimedia content, including both text representation and binary representation.

6. The descriptive data structure of claim 5, wherein the digital rights information is a pointer to link a user to a property rights database.

7. The descriptive data structure of claim 5, wherein the data structure is bearer independent.

8. A descriptive data structure embodied on computer-readable medium to provide for management of multimedia content comprising:
routing information;
digital rights information; and
a pointer to a location where a plurality of multimedia content may be retrieved.
